(19) United States
(12) Patent Application Publication
(10) Pub. No.: US 2013/0179247 A1
(43) Pub. Date: Jul. 11, 2013

(54) Frequency Reward Method and System for Matching a Debit Card Buyer with an Advertiser Willing to Pay for a Sale

(71) Applicants: David B. Sutton, Monroe, MI (US); Douglas E. Blasimen, Bowling Green, MI (US)

(72) Inventors: David B. Sutton, Monroe, MI (US); Douglas E. Blasimen, Bowling Green, MI (US)

(73) Assignee: PRIVACASH, INC., Monroe, MI (US)

(21) Appl. No.: 13/544,474

(22) Filed: Jul. 9, 2012

Related U.S. Application Data
(63) Continuation-in-part of application No. 12/757,329, filed on Apr. 9, 2010, now Pat. No. 8,219,474.
Application No. 12/757,329 is a continuation of application No. 10/851,927, filed on May 21, 2004, now abandoned.
Application No. 10/851,927 is a division of application No. 09/363,499, filed on Jul. 29, 1999, now abandoned.

(51) Int. Cl. G06Q 30/02

(52) U.S. Cl. CPC G06Q 30/0224
USPC 705/14.25

(57) ABSTRACT

A method is provided for rewarding purchasers of prepaid debit cards and card reload packs by providing incentives based on the purchasers' buying history and user profile.

### CROSS-REFERENCE TO RELATED APPLICATIONS

This application is a continuation-in-part of U.S. application Ser. No. 12/757,329 filed Apr. 9, 2010, which is a continuation of U.S. application Ser. No. 10/851,927 filed May 21, 2004, which in turn, is a division of U.S. application Ser. No. 09/363,499 filed Jul. 29, 1999, now abandoned

### BACKGROUND

The present invention relates generally to a method for making a purchase over the Internet, and more particularly to a method of transacting an anonymous purchase through the use of intermediary credit account information.

Currently, a consumer wishing to make a purchase over the Internet must utilize their personal credit card. Secured servers utilized by online vendors accept credit cards and provide protection, via various encryption processes, for the interception of credit card information by third party “hackers”. However, even if no “hacking” takes place, the vendor ultimately has the consumer's credit card number. Having the credit card number provides a trail back to the consumer's social security number and other private and personal information which the consumer would not normally circulate.

Possession of the credit card number, in effect, gives the vendor the opportunity to circulate information regarding the consumer, including the consumer's history of purchases which may be utilized for mass targeted mailings as well as any other marketing objectives. In addition, by using ones credit card, those purchases made over the Internet that a consumer may otherwise wish to keep confidential appear on the consumer's monthly credit card statement, and thus are available to others having access to the statement. In other words, circulating information relating to the consumer's purchase could prove to be damaging to the consumer. The current mechanism for transacting purchases over the Internet could lead to irreparable harm and embarrassment to one's credit standing as well as one's personal and professional business life. Accordingly, there is a significant need for a means by which a consumer may confidentially make a purchase over the Internet.

Therefore, it is desirable to provide a method of transacting an anonymous purchase through the use of intermediary credit account information. The purchase should be “untraceable” simulating a “cash” transaction which typically occurs in a typical “bricks and mortar” retail setting. This need will continue to grow exponentially as commercial transactions over the Internet continue to grow. Moreover, there is a rapidly growing need for those consumers who do not have access to a credit card to be able to conduct commercial transactions over the Internet. For instance, due to their credit history or age, there are numerous consumers who do not qualify for a credit card account. These types of consumers are fundamentally prohibited from participating in any Internet commerce transaction.

It is widely known that prepaid debit cards are often purchased as gifts. The utility and wide acceptance of debit cards save time and effort rather than the frustrating of trying to select the right gift for the recipient. The debit card recipient can then select their favorite gift and with universal acceptance, the debit card provides the ability to do so. Though the gift giver could give cash, the growing popularity of internet purchases precludes the use of cash. Therefore, a debit gift card offers a more universally accepted means of payment.

Such debit cards can tend to be addictive for gift givers. Though debit card gifts may be considered to be impersonal, the recipient receives the ultimate freedom in selecting their own gift. At the same time the debit card giver can become somewhat fatigued with the cost associated with purchasing a debit cards at retail outlets. In addition to the face value loaded on the card there is a card acquisition fee paid by the debit card buyer at the time the card is purchased at the retail location. Though the purchasing power of a $50.00 debit card may be $50.00, the actual acquisition cost of the card may be $54.95 or more. This represents a 10% premium over the face value. In this instance, the card provider charges a $4.95 acquisition fee for making the card available for purchase. With the frequency of card purchases growing exponentially card buyers often become disappointed with the demonstration of value to them personally. They may not consider the time savings or convenience. This can be especially disappointing if the card buyer purchases large volumes of debit cards as gifts for multiple recipients thought out the year. Accordingly, they may elect to give cash or a conventional gift.

At the same time, debit card providers, banks or program managers are coming under the increasing pressure of competition with other card providers. Many debit cards are viewed as substantially equivalent with another brand being offered in the same retail location. Price erosion by reducing acquisition or user fees has a direct negative impact to the income of the debit card provider.

### SUMMARY OF THE INVENTION

In accordance with the present invention, a method is provided for transacting an anonymous purchase over the Internet. The method comprises the steps of: (a) acquiring intermediary credit account information from a purchasing intermediary; (b) providing transactional purchase information, including the intermediary credit account information, to a retailer, where the transactional purchase information is provided by the purchaser using a first computing device of a computer-implemented purchasing system; and (c) transacting a purchase between the purchaser and the retailer using the intermediary credit account information, thereby maintaining the anonymity of the purchaser.

For a more complete understanding of the invention, its objects and advantages, refer to the following specification and to the accompanying drawings.

### BRIEF DESCRIPTION OF THE DRAWINGS

FIG. 1 is a diagram illustrating the basic components of a conventional computer-implemented purchasing system;

FIG. 2 is a flowchart showing a method for transacting an anonymous purchase in accordance with the present invention;

FIG. 3 is a detailed flow diagram of the method for transacting an anonymous purchase in accordance with the present invention;

FIGS. 4A and 4B are a front and back view, respectively, of an exemplary pre-paid purchasing card in accordance with the present invention;

FIG. 5 is a detailed flow diagram of an alternative method for transacting an anonymous purchase in accordance with the present invention;

FIG. 6 is a detailed flow diagram of a method for rewarding frequent card purchasers;

FIG. 7 is a detailed flow diagram of an alternative method for rewarding frequent card purchasers; and

FIG. 8 is a simplified diagram of the parties involved in the system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

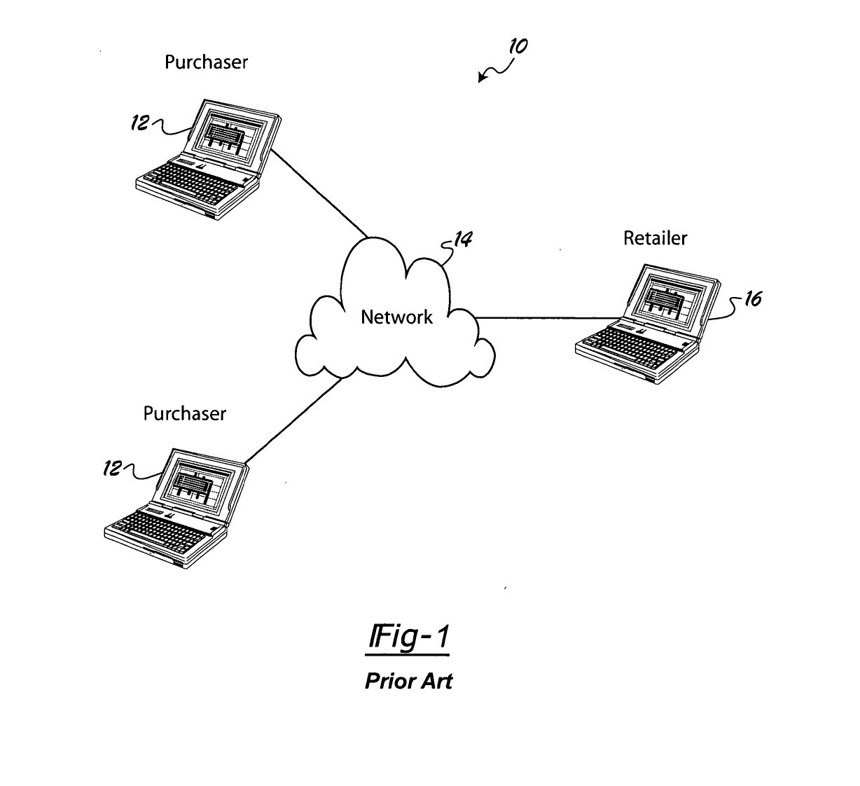

FIG. 1 illustrates the basic components of a conventional computer-implemented purchasing system 10. The purchasing system 10 is comprised of a plurality of purchasing computing devices 12 interconnected via a network 14 (e.g., the Internet) to at least one retail computing device 16. As will be apparent to one skilled in the art, the computing devices are able to communicate using common communication protocols (e.g., TCP/IP) over different types of network channels. For illustration purposes, a preferred embodiment of the computing device is a personal computer (PC). Of course, it will be appreciated that the principles of the invention can be employed in a wide variety of computing devices, including but not limited to a telephone, a television or a personal digital assistant (PDA).

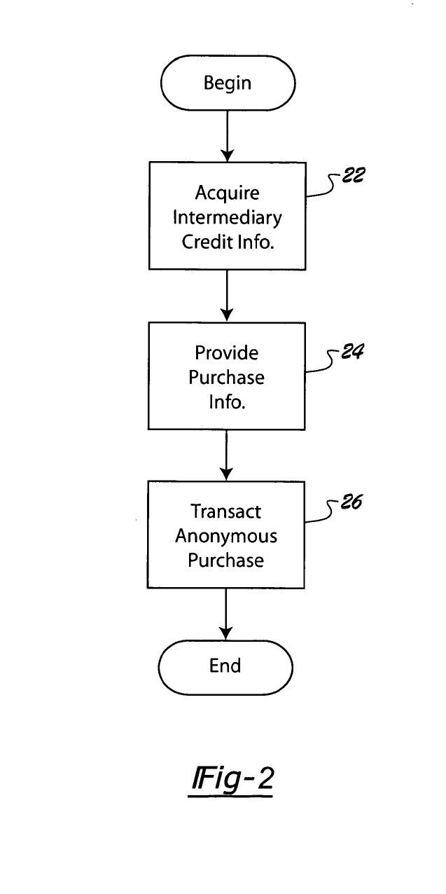

In accordance with the present invention, an overview of a method for transacting an anonymous purchase using the computer-implemented purchasing system 10 is shown in FIG. 2. First, a purchaser must acquire intermediary credit account information 22 from a purchasing intermediary. Next, the purchaser provides transactional purchase information 24, including the intermediary credit account information, to a retailer, using a purchasing computing device connected to the network 14. Lastly, a purchase is transacted 26 between the purchaser and the retailer through the use of the intermediary credit account information, thereby maintaining the anonymity of the purchaser. While the following description is provided with reference to an intermediary credit account, it is readily understood that an intermediary debit account is within the scope of the present invention.

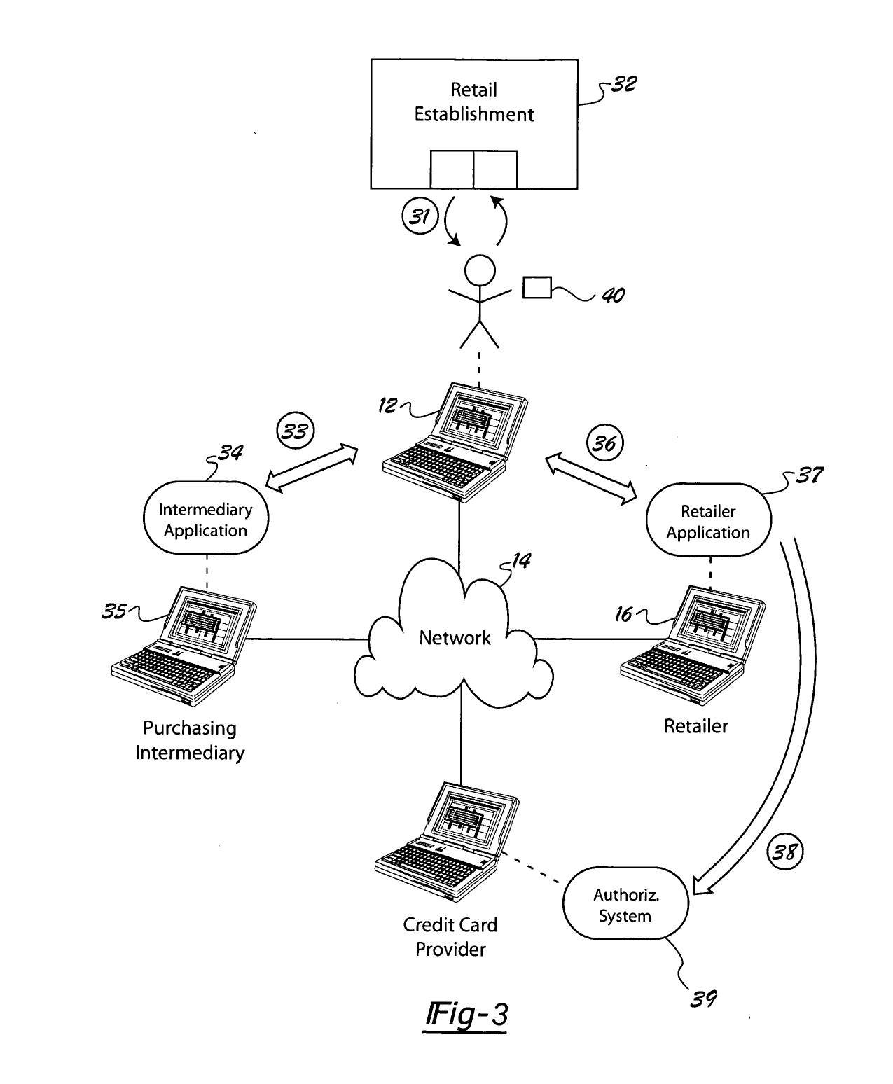

A more detailed description of the method of the present invention is provided in conjunction with FIG. 3. The method of the present invention operates in a similar fashion to that of a pre-paid phone card. The primary objective of the method is to create a non-traceable means to transact a purchase over the Internet. In order to accomplish this task, there must exist a procedure for converting “real currency” to “Internet currency”. In the context of this discussion, “real currency” refers to credit on a credit card or actual currency issued by a national treasury of any country. Therefore, a currency conversion must take place via an intermediary web site over the Internet or in a “bricks and mortar” retailer.

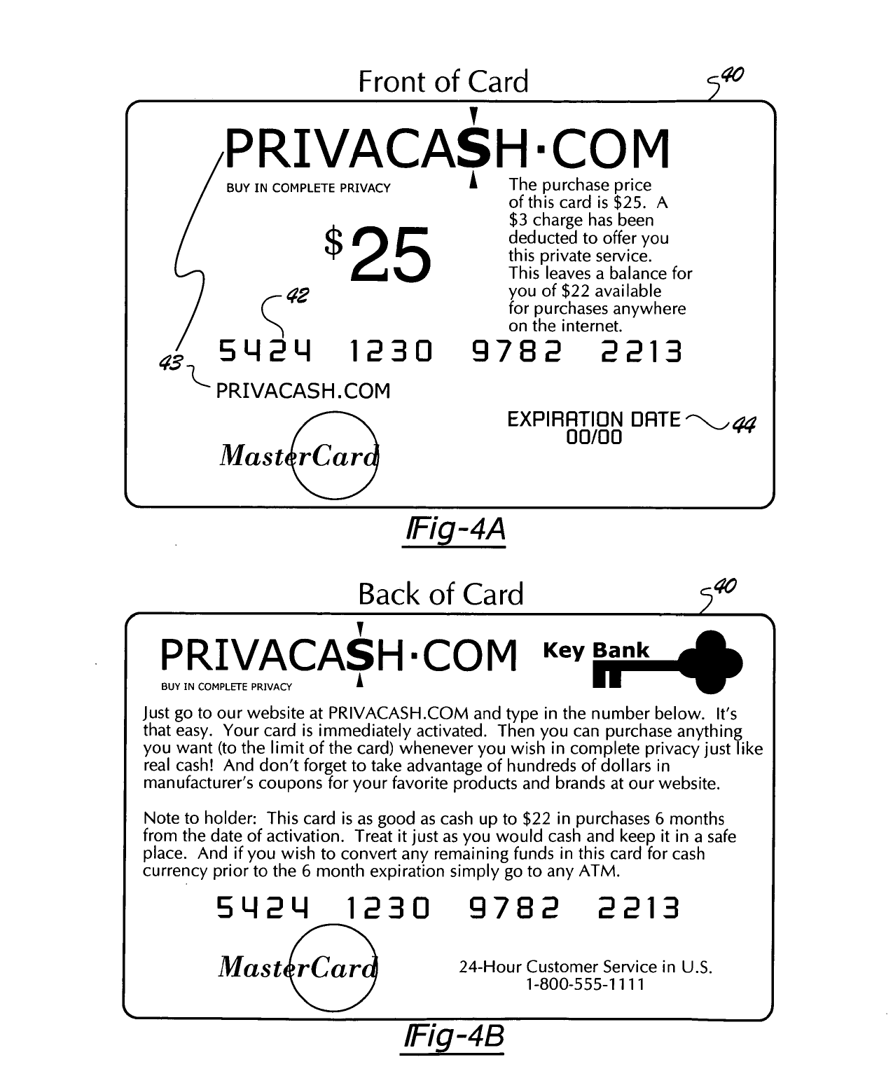

In the case of the “bricks and mortar” retailer, a pre-paid purchasing card is to be offered by the retailer in various predetermined denominations (e.g., $25, $50, or $100). The consumer would visit the retail establishment 32, such as a 7-11 store, a WAL-MART store, or a RITE-AID store, to buy 31 one or more purchasing cards. An exemplary purchasing card 40 is shown in FIGS. 4A and 4B. The purchasing card 40 includes a unique and on-traceable Master Card or Visa credit account number 42, a non-personalized cardholder name 43 (such as the name of the purchasing intermediary) and an expiration date 44 which allows the consumer the ability to make a purchase(s) over the Internet or in other “bricks and mortar” retail establishments. It is envisioned that the card will have a predetermined expiration (e.g., six months) from the date the consumer activates the card. As will be more fully explained below, there is also a credit limit associated with each purchasing card.

Each purchasing card 40 is a non-recourse credit card issued by a credit card provider (e.g. CITIBANK, BANCONE, etc.). The credit card provider sells blocks of purchasing cards to a purchasing intermediary 35. Each purchasing card is sold for a predetermined denomination (e.g. $23, $47 or $97) which corresponds to a credit limit that it associated with the purchasing card 40. The purchasing intermediary 35 in turn sells each purchasing card 40 at a slightly higher cost to a consumer. For instance, a consumer would pay $25 for a purchasing card 40 which has an available credit limit of $22. The $3 difference in cost is a service fee captured by the purchasing intermediary 35. It should also be noted that as additional inducement for providing the actual physical purchasing cards, the credit card provider may receive a fee from the purchasing intermediary for each card which is activated and/or used by a consumer.

The purchasing cards are provided on a consignment basis by the purchasing intermediary 40 to participating retailers 32. Amongst other incentives, the retailer may also receive a fee from the purchasing intermediary for each purchasing card which was purchased at their retail establishment.

The consumer then buys the purchasing card 40 at the retailer establishment 32 either by charging the purchase on the consumer's credit card or through an exchange of actual cash currency. If the consumer elects to buy the purchasing card 40 with a credit card, then consumer's monthly billing statement from the credit card provider simply shows the name of the retailer and the aggregate amount of the purchase. On the other hand, if the consumer elects to buy a purchasing card 40 with cash currency there is no post purchase confirmation process.

In either case, the credit account number on the purchasing card 40 is not part of the transaction, and thus is not linked to the consumer. In other words, each purchasing card 40 is a “bearer card” which means it is as good as cash. Should the consumer lose or misplace the purchasing card 40, it may be used up to the limit available on the card by anyone in possession of the card. In this way, the purchasing card provides a means for preserving the anonymity of the purchaser in future purchases made over the Internet.

Once the consumer buys the purchasing card 40, they then need to activate 33 of their purchasing card 40 by contacting the purchasing intermediary 35. It is envisioned that an intermediary software-implemented application 34 resides on a computing device which is operated by the purchasing intermediary 35. Thus, the intermediary application 34 may be accessed by the consumer via the network 14 using a purchasing computing device 12. More specifically, the intermediary application 34 may be associated with a web site on the internet, where an address for the web site is provided on the purchasing card 40. The intermediary application 34 is receptive of the credit account number as entered by the consumer and operative to activate the card.

To do so, the intermediary application 34 interfaces with a data store which maintains a record for each purchasing card acquired by the purchasing intermediary. Each record includes the account number, the non-personalized cardholder name, the expiration date, a credit limit, an activating flag and other types of account information as is known in the art.

The intermediary application 34 is receptive of the credit account number as entered by the consumer and operative to activate the card. To do so, the intermediary application 34 interfaces with a data store which maintains a record for each purchasing card acquired by the purchasing intermediary. Each record includes the account number, the non-personalized cardholder name, the expiration date, a credit limit, an activation flag and other types of account information as is known in the art.

In order to activate their card, the consumer enters the credit account number shown on the purchasing card into the intermediary application 34. No further information is requested of the consumer. One skilled in the art will readily recognize that to activate the purchasing card 40, the intermediary application 34 may interface with an additional authorization system as provided by the credit card provider. Upon activation, the consumer has a set time from the activation date to exhaust the available funds of their purchasing card 40. While the above description discusses contacting the purchasing intermediary via the network, it is readily understood that other means are available for contacting the purchasing intermediary (e.g., via the telephone), thereby activating the purchasing card 40.

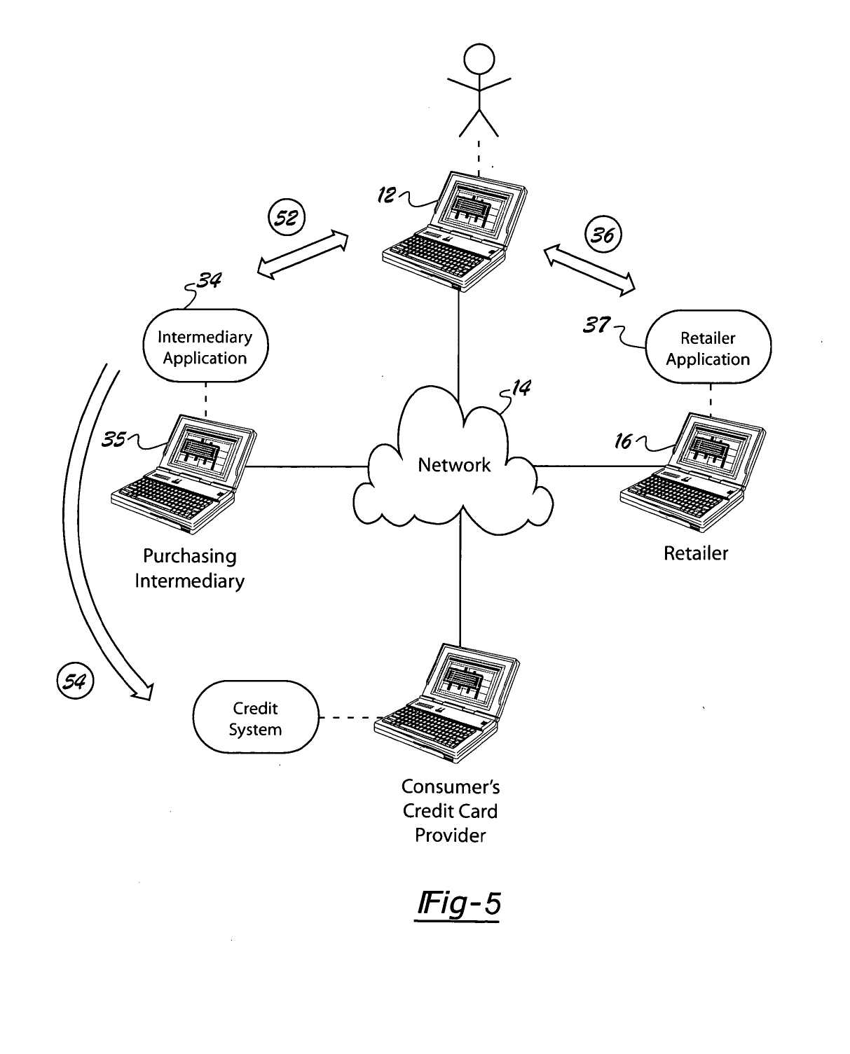

An alternative means for acquiring intermediary credit account information is described in relation to FIG. 5. Rather than visiting a retail establishment, the consumer may directly access 52 the intermediary application 34 in order to obtain intermediary credit account information. Instead of receiving a purchasing card, the consumer merely acquires the intermediary credit account information over the network 14. In this case, the intermediary application 34 is receptive of credit card information from the consumer and operative to provide intermediary credit account information to the consumer.

As part of this process, the consumer's credit card is debited 54 for the cost (e.g., $25, $50 or $100) associated with acquiring the intermediary credit account information. As previously explained, the intermediary credit account information includes a credit account number, an expiration date, and a credit limit (e.g., $23, $47 or $97) which is slightly less than the cost associated with the service. The consumer's monthly billing statement from the credit card provider will simply show the name of the purchasing intermediary and the aggregate amount of the purchase. Again, the intermediary credit account information is not linked to the consumer, thereby maintaining the anonymity of the purchaser in future Internet transactions.

Once the consumer acquires intermediary credit account information, they are free to use it to make an online purchase over the Internet as shown in either FIG. 3 or FIG. 5. The consumer must first access a retailer's software-implemented application 37 in order to transact a purchase 36. It is envisioned that the retailer's application 37 resides on the retailer's computing device 16 which is accessed via the network 14 using a purchasing computing device 12. In particular, the retailer's application 37 may be associated with a web site on the Internet. Furthermore, the retailer's application 37 is receptive of purchase transactional information from the consumer and operative to transact a purchase with the consumer over the network 14.

When the consumer is ready to make a purchase, they are prompted through a series of payment and shipping questions to provide purchase transactional information. As will be apparent to one skilled in the art, the purchase transactional information describes the purchased goods or services as well as provides payment information from the consumer, including the credit account number associated with the intermediary credit account information. The intermediary credit account further provides at least some pseudo purchase transactional information to the consumer. For instance, each purchasing card may have the same or a different non-personalized cardholder name listed on the card. When the consumer is prompted by the retailer's application 37 to provide a name, they simply insert the cardholder name, for example the name of the purchasing intermediary or an alias such as “John smith” as provided on the card. The consumer will also be prompted to provide the credit account number and the expiration date associated with the purchasing card. The account number, cardholder name and/or expiration date may then be used by the retailer's application to complete the purchase transaction with the consumer in a manner known in the art. One skilled in the art will readily recognize that as part of transacting the purchase, the retailer's application 37 may verify 38 that the purchase price does not exceed the credit limit associated with the purchasing card. To do so, the retailer's application 37 may interface with an additional authorization system 39 as provided by either the purchasing intermediary or the credit card provider.

Of course, the consumer is free to make other purchases up to the credit limit associated with their intermediary credit account. In the case the purchasing card, the card can be discarded once the funds on the purchasing card are exhausted. In addition, any residual funds remaining on the consumer's purchasing card may be drawn out (e.g., using any ATM facility or bank) prior to the expiration date by the consumer.

In the event that the purchase is for goods which need to be shipped to the consumer, the consumer will also need to provide shipping instructions. The consumer has two options: (1) provide a shipping address (i.e., home or business address) or (2) utilize a forwarding service provided by the purchasing intermediary. It is noteworthy that the consumer's address does not alone generally ensure access to a consumer's credit history and other confidential personal information. Thus, a consumer may opt to provide a shipping address and yet retain anonymity from the retailer.

In the latter case, the goods will be shipped to the purchasing intermediary who will then ship the goods to the consumer. To do so, the intermediary credit account information provides an intermediary shipping address which the consumer can provide to the retailer. The consumer's shipping address may be captured by the purchasing intermediary when the consumer is activating their purchasing card, and then, upon receipt of the goods from the retailer, it is used to ship the goods to the consumer. An additional service fee covering at least up to the shipping costs may be charged by the purchasing intermediary to the consumer. It is envisioned that the service fee may be debited to the available funds remaining on the purchasing card.

It is widely known that large retailers spend considerable money to circulate discount coupons to consumers. The present invention offers an alternative distribution channel for these retailers. In particular, the intermediary application 34 may further be operative to provide discount coupons to the consumer. While the consumer is either activating their purchasing card or acquiring intermediary credit account information, the consumer may select from a menu of participating retailers. The consumer would then be directed to a web site or other type of software application where they could check to see if any discount coupons were being offered by the retailer. If so, they could simply print the coupon on a printer attached to their local computing device 12. The consumer may also be asked to answer a short series of non-personal questions in conjunction with obtaining the coupon. The questions are typically designed to determine relevant product user information. By enabling retailers the ability to offer their coupons in conjunction with this service, the purchasing intermediary is then able to change a service fee to the retailer, thereby deriving another revenue stream.

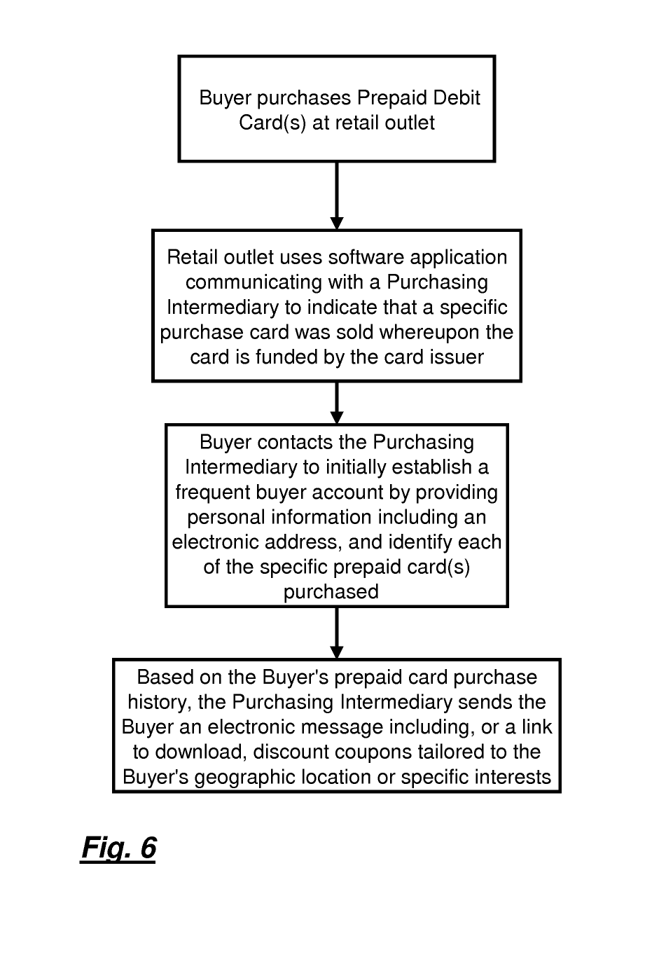

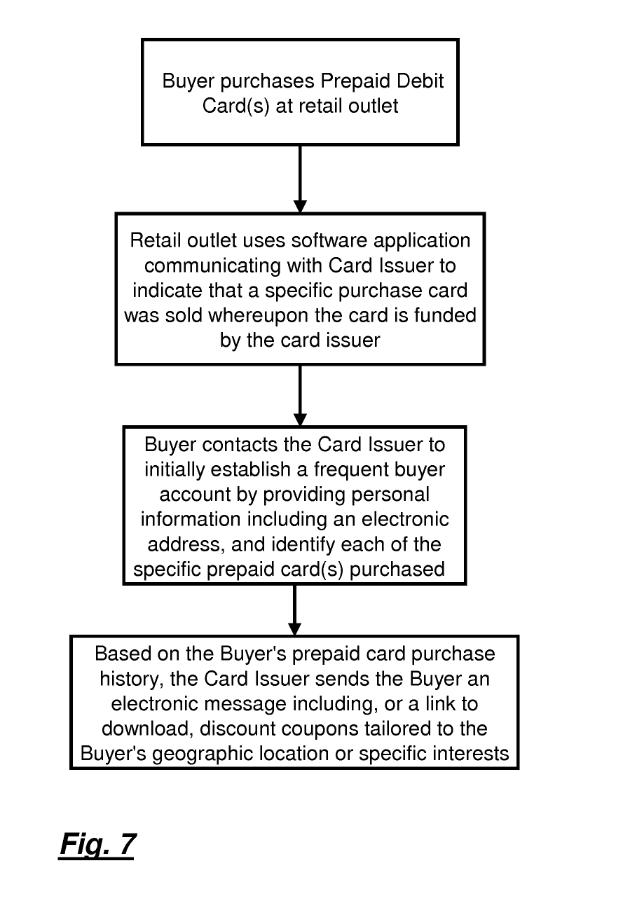

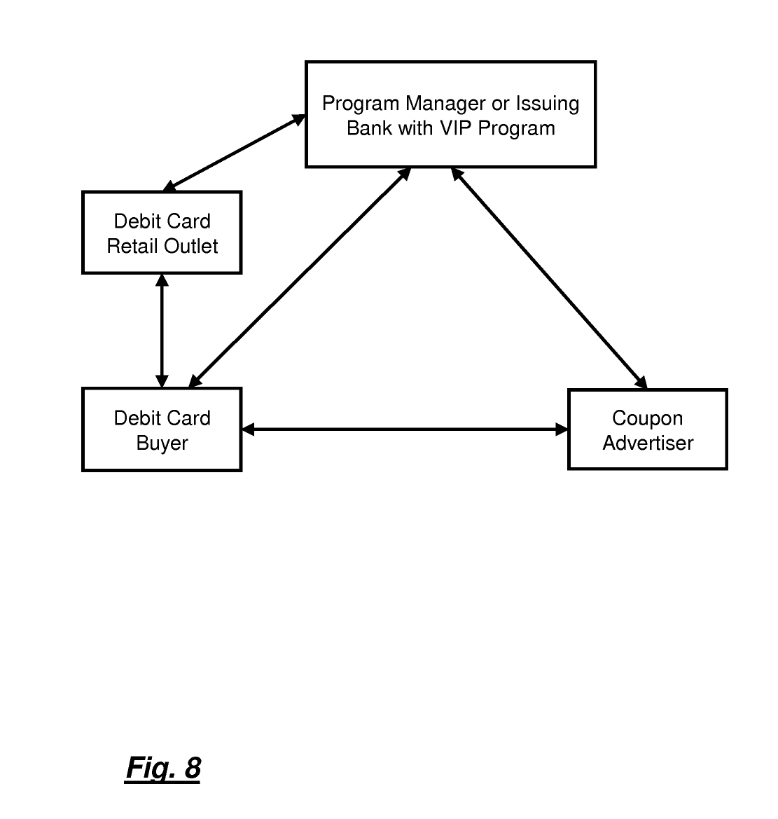

In order to encourage purchasers to purchase prepaid debit cards from a specific issuing bank or from a specific branded card distributed by a program manager, the present invention enables the establishment of a frequent buyer program to provide incentives to purchasers. Frequent buyer programs are illustrated schematically in FIGS. 6 and 7. These programs are similar in nature. The program illustrated in FIG. 6 is a system administered by a purchase intermediary or program manager acting between the retailer and a prepaid card issuing bank. In FIG. 7, the program is administered by an issuing bank directly or by those acting under the issuing bank's direction and control. The involved parties are shown in one example in FIG. 8. As described previously, prepaid cards are distributed in an unfunded state to retailers. When the card is sold preferably point-of-sale software at the retailers communicate with program manager or issuing bank, to activate the card and load the necessary funds. The frequent buyer program is maintained by the program manager or issuing bank and enables the purchaser of a prepaid card to establish a frequent buyer account and register new card and reload pack purchases. When the frequent buyer account is established, the purchaser provides certain personal information including an electronic address such as an email address and other personal identifying information which can include a physical address, hobbies, or other interests. Based upon the purchaser's purchase history, various incentives will be provided which increase in perceived value as the purchases card load volume increases. When additional cards or reload packs are purchased the frequent buyer account holder may logon to his/her account and register their new purchases. The incentives provided could be the traditional incentives such as airline tickets or free merchandise available from a catalogue. Preferably, the incentives will be in the form of discount coupons provided to the purchaser which are matched to the purchaser's geographic location or personal interests. In this way, the incentives could be electronically distributed and incentives having a relatively high perceived value can be obtained with little or no costs to the program manager or a card issuing bank running the program.

One embodiment of the present system is designed to act as a hub to link a debit card buyer to an advertiser and complete a sale. This system could be offered directly by the debit card provider, a third part value added reseller, a retailer, a marketing company or any combination. We will call this the value added retailer (VAR).

The purpose is to offer the best possible incentive to debit card buyers at the lowest price that an advertiser is willing to pay for a sale and then close the sale. It is intended to stimulate debit card sales and distinguish a debit card brand by: i) identifying what a card buyer wants to buy and would be willing to pay, and ii) what an advertiser is willing to offer as a discount to basically buy a sale, and iii) closing a sale. This system links the two together for mutual success to complete an actual sale transaction.

First, to reduce the card buyer frustration as previously described, this system offers a dynamic incentive for regular card purchasers. It could also be used by a card buyer if they purchased the card for personal use. This is often the case if the buyer does not have a credit card and they are interested in making a purchase on the internet or would prefer not to use their personal credit card for internet or other purchases.

Second, advertisers pay to market their products. Online firms like Google offer marketing products like Adwords that offer online advertisers willing to pay for impressions based on key word searches. It is fairly technical for advertisers to choose the correct key words that create impressions that lead to clicks that most importantly link to actual sales. The system is based on Cost Per Click (CPM) which may or may not generate a sale. Therefore, the advertiser pays for a click but often does not realize a sale since the Google algorithm produces a quality score based on a number of variables only one of which is the price the advertiser is willing to pay for a click. The quality score is what determines the order in which their ad appears. The highest quality score places the advertiser in the number one position and so on. The advertiser often may if at all, realize sales through trial and error; balancing key words, the cost they are willing to pay for a click in trying to boost their quality score. All through the trial and error process, Google realizes income for ad sales placements.

Therefore, using the present system it is possible to link card buyers willing to complete a sale with advertisers willing to “buy” a sale in a real world setting.

Viewing the card sale process from the perspective of the debit card buyer, (the VIP program), when a buyer selects a debit card in a retail location the packaging would have a concealed tamper proof sticker “concealed buyer number” (CBN). This number would be maintained in a secure database that is linked to the card account number on the inside of the packaging. After the debit card is purchased, the tamperproof sticker can be accessed without opening the debit card packaging. And, it would be visually obvious if the CBN had been previously accessed for potentially fraudulent purposes. In such case, the debit card buyer could just select another debit card packaging. The principle inducement of the VIP program is directed to the card buyer but could be extended to the card recipient as well.

When the gift card is purchased at the retail location, it would activate both the debit card account number and the CBN number. The database containing these records would show the debit card account as being “active”. If someone were to tamper with the gift card packaging without purchasing the card and then attempted to register the CBN for their own benefit, the database would reject their request as it would show that the card record associated with the CBN was unsold and therefore the CBN was inactive as well.

After debit card purchase, if the card buyer wishes to take advantage of the VIP program they must first establish their personal VIP number on the VAR's website. Then, each time they purchased a debit card they could link it their personal VIP number they established the first time they purchased a gift card assuming they elected to do so. All the debit cards they purchased could be linked to their VIP number. At the time the card buyer first sets up their VIP account and links the first CBN, they would be asked for various buying preferences that would enable a specially designed algorithm or related artificial intelligence to design a buyer profile that would create a benefits package especially designed for the VIP buyer. Then, with each card link they would be moved to more valuable offers that correspond to their preferences.

It is envisioned there could be a standard and enhanced benefits packages offered depending on how often the card buyer purchases debit cards. The standard benefits package would of course provide significant and clear benefit for the debit card buyer in excess of the card convenience fee they were charged when they purchased the debit card. For example, the VAR software could offer a VIP a selection with a $25 discount. This approach is intended to not only satisfy any consumer reluctance to purchase debit cards, but to act as an incentive to purchase more debit cards. The more cards the debit card buyer purchased the more valuable and exclusive the collection would be available to them.

More frequent debit card buyers would have access to more enhanced “matching” features. These enhanced features would more directly match the card buyer with advertisers willing to stimulate a sale.

As a part of the matching, on the VAR's website there would be a screen for advertiser registration. This would include advertiser registration information including the advertiser's settlement account for the purposes of reconciling advertising with sales. The advertiser could offer to sell discounts for various goods and services. Advertisers traditionally determine what they are willing to pay for a sale. For example, Wednesdays could be the slowest day at Applebee's so they may wish to generate traffic to their stores on Wednesday. They may be willing to offer a coupon for a $50 dinner package for $25; in doing so they may feel generating more traffic and more consumer exposure to their restaurants could generate additional future sales at full price. The VIP that selects this offer would purchase the offer with their personal credit card at the VAR website check out. After payment is completed, a receipt and one time barcode specific for this purchase would be printed on the VIP's printer which would be redeemed at the time they visit the advertiser's location. The VAR would charge the advertiser a success fee since based on each successful sale. The payment settlement would occur immediately so the advertiser would not have to wait for their money. The VIP would receive their discount coupon, the VAR would receive a success fee, and the Advertiser's settlement account would be credited the amount of the sale less VAR's success fee. Any returns, adjustments, etc., would be managed by the advertiser as is normal.

The advertisers with the best offers that match the needs of the VIPs would generate the most confirmed sales and most revenue. The debit card brand offering the VIP program would have a distinct advantage over the other debit card brands.

In one preferred embodiment of the frequent buyer program, the purchaser is sent a rewards email providing a plurality of links to discount coupons for various goods and services which can be acquired at a local retail, restaurant or entertainment venues. The frequent buyer program can maintain a log of coupon previously provided or coupon links selected and accordingly match future coupons to the purchaser's preference history and limiting the overuse of coupons by a card holder at any one particular retailer or entertainment venue. Retailer, restaurant and entertainment venues have an incentive to participate in the program and provide significant discounts in the form of coupons in order to attract qualified customers in their local geographic market. The number of coupons the purchaser can utilize at any one retailer in a given time period can be limited to limit over use. This coupon distribution method limits lost revenue which would occur in a publicly advertised sale and while exposing the retailer, restaurant or entertainment venue to a group of potential new customers in a target geographic market or who have specific interests.

While the above description constitutes the preferred embodiment of the invention, it will be appreciated that the invention is susceptible to modification, variation, and change without departing from the proper scope of fair meaning of the accompanying claims. While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for rewarding purchasers of prepaid debit cards and prepaid debit card reload packs, comprising:
distributing unfunded prepaid debit cards and reload packs at retail outlets;
receiving an electronic communication from the retail outlet when a prepaid debit cards or reload pack is sold to a purchaser;
funding the prepaid debit cards or reload pack upon receipt of the electronic communication from the retailer;
maintaining a web site enabling a purchaser to establish a frequent buyer account by providing personal information including an electronic address, and identify each of the specific prepaid card or reload packs purchased; and
based on the purchaser's prepaid card purchase history, sending to the purchaser's electronic address discount coupons tailored to the purchaser's geographic location or specific interests.

2. The method of claim 1 wherein the steps are carried out by a program manager acting as an intermediary between the retailer and a prepaid card issuing bank.

3. The method of claim 1 wherein the steps are carried out by or controlled by a prepaid card issuing bank.

4. The method of claim 1 wherein the perceived value of the coupons sent to the purchaser increase as load volume increases.

5. The method of claim 1 wherein the coupons are provided by supplying a link enabling the purchaser to download the discount coupons.
